(19) United States
(12) Patent Application Publication
(10) Pub. No.: US 2011/0016769 A1
(43) Pub. Date: Jan. 27, 2011

(54) LIVE TRAP FOR TRAPPING RODENTS

(75) Inventors: James H. Cink, Ballwin, MO (US); Jonathan D. Berger, St. Louis, MO (US); Brian James Mann, Wildwood, MO (US); Edward Francis Marshall, Lansing, MI (US); Henry Wayne Moran, Ballwin, MO (US); James David Poling, Clarkson Valley, MO (US)

Correspondence Address: Patent Docket Department;Armstrong Teasdale LLP, 7700 Forsyth Boulevard, Suite 1800, St. Louis, MO, 63105, US

(73) Assignee: BASF CORPORATION, Florham Park, NJ (US)

(21) Appl. No.: 12/671,167

(22) PCT Filed: Sep. 21, 2009
(86) PCT No.: PCT/US2009/057689

§ 371 Date: May 14, 2010

Related U.S. Application Data
(60) Provisional application No. 61/099,198, filed on Sep. 22, 2008.
(60) Provisional application No. 61/099,111, filed on Sep. 22, 2008.
(60) Provisional application No. 61/231,557, filed on Aug. 5, 2009.

(51) Int. Cl. A01M 23/08; A01M 23/04; A01M 1/14; A01M 23/00

(52) U.S. Cl. 43/65; 43/60; 43/69; 43/114; 43/67

(57) ABSTRACT

A live trap is provided for trapping rodents. The live trap includes a housing having an interior space and at least one opening through which rodents enter the interior space of the housing. A first trap mechanism is provided that is positionable in the live trap for trapping rodents within the live trap. A second trap mechanism is provided that is different from the first trap mechanism and positionable in the live trap for trapping rodents within the live trap. The live trap and trap mechanisms are configured for selective releasable securement of each of the respective first and second trap mechanisms in the live trap to permit interchangeable use of the first and second trap mechanisms in the live trap.

### BACKGROUND

The present invention relates generally to traps for the live capture of rodents. Live traps are designed to trap a rodent, typically a mouse, within an enclosure without having to poison or immediately kill the rodent. Such traps typically include a trap mechanism in the form of a ramp and a trap door that closes behind the rodent as the rodent moves over the ramp. The housing is designed to inhibit non-targeted animals (e.g., dogs, cats) and unauthorized individuals (e.g., children) from accessing the interior of the trap. Some traps may also have a glue board or other adhesive on the floor of the trap to restrict movement of the rodent once the rodent is trapped therein.

One drawback associated with these prior art live traps is the tendency for rodents that enter the trap to move beneath the ramp and become stuck (e.g., by the glue board) or expire under the ramp. Such an occurrence inhibits the ramp from further movement and therefore prevents additional rodents from entering and becoming trapped within the trap.

### BRIEF DESCRIPTION

In one aspect, a live trap is provided for trapping rodents. The live trap comprises a housing having an interior space and at least one opening through which rodents enter the interior space of the housing. A first trap mechanism is provided that is positionable in the live trap for trapping rodents within the live trap. A second trap mechanism is provided that is different from the first trap mechanism and positionable in the live trap for trapping rodents within the live trap. The live trap and trap mechanisms are configured for selective releasable securement of each the respective first and second trap mechanisms in the live trap to permit interchangeable use of the first and second trap mechanisms in the live trap.

In another aspect, a live trap for trapping rodents is provided. The live trap comprises a housing having an interior space, a bottom having an inner surface at least in part defining the interior space, and at least one entry opening through which rodents enter the interior space of the housing. At least one trap mechanism is disposed within the interior space of the housing to inhibit rodents that enter the housing from exiting the housing. A bridge assembly is positioned within the interior space of the housing. The bridge assembly includes a platform spaced above the inner surface of the bottom of the housing and configured to support the at least one trap mechanism above the inner surface of the bottom of the housing. The bridge assembly extends above less than the entire inner surface of the bottom of the housing to permit rodents exiting the trap mechanism to step down from one of the bridge assembly and the at least one trap mechanism onto the inner surface of the bottom of the housing.

In yet another aspect, a live trap for trapping rodents is provided. The live trap comprises a housing having an interior space, a bottom panel having an inner surface at least in part defining the interior space, at least one upstanding wall extending up from the bottom panel, at least one entry opening through which rodents enter the interior space of the housing, and at least one inspection member separate from the at least one entry opening and disposed on at least one of the bottom panel and the at least one upstanding wall. The at least one inspection member is configured to permit viewing of the interior space of the housing. At least one trap mechanism is disposed within the interior space of the housing to inhibit rodents that enter the housing from exiting the housing.

In still yet another aspect, a live trap for trapping rodents is provided. The live trap comprises a housing having an interior space, a bottom panel including an inner surface at least in part defining the interior space of the housing, and at least one entry opening through which rodents enter the live trap, the bottom panel including an access opening and an access panel positionable between a closed position for of use of the live trap and an opened position for servicing of the live trap. A trap mechanism that is releasably positionable in the live trap for trapping rodents within the live trap is provided. The trap mechanism is disposed within the interior space of the housing in sufficient proximity to the access opening to permit access to the trap mechanism in the opened position of the access panel.

In still yet another aspect, a live trap for trapping rodents is provided. The live trap comprises a housing having an interior space, a top, a bottom panel including an inner surface at least in part defining the interior space of the housing, and at least one entry opening through which rodents enter the live trap. The housing comprises a trap portion in which rodents are trapped within the live trap and an inlet portion in open communication with and extending outward from the trap portion. The entry opening of the housing is at the inlet portion thereof. A trap mechanism is disposed at least in part within the inlet portion of the housing in spaced relationship with the entry opening of the live trap. The housing further comprises a plurality of blocking members depending from the top of the housing at the inlet portion and arranged in longitudinally spaced relationship with each other along the inlet portion to inhibit rodents trapped within the live trap against manipulating the trap mechanism to escape from the trap.

### BRIEF DESCRIPTION OF THE DRAWINGS

FIG. 1 is a perspective view of one embodiment of a live trap in a closed configuration of the trap;

FIG. 2 is a perspective view thereof in an opened configuration of the trap;

FIG. 3 is a top plan view of the live trap of FIG. 1;

FIG. 4 is a bottom plan view thereof;

FIG. 5 is a left side elevation thereof;

FIG. 6 is a perspective view of a second embodiment of a live trap with the trap illustrated in an open configuration of the trap, and with a trap mechanism of the live trap in the form of a ramp and trap door assembly;

FIG. 7 is a cross-section taken in the plane of line 7-7 of FIG. 3;

FIG. 8 is a perspective view of a third embodiment of a live trap with the trap illustrated in an open configuration of the trap, and with a trap mechanism of the live trap in the form of a pair of swing doors;

FIG. 9 is longitudinal cross-section of the live trap of FIG. 8;

FIG. 10 is a perspective view of a swing door trap mechanism of the live trap of FIG. 8;

FIG. 11 is a perspective view of a fourth embodiment of a live trap with the trap illustrated in an open configuration of the trap, and with a trap mechanism of the live trap in the form of a funnel;

FIG. 12 is a longitudinal cross-section of the live trap of FIG. 11;

FIG. 13 is a perspective view of a funnel trap mechanism of the live trap of FIG. 11;

FIG. 14 is a perspective view of a fifth embodiment of a live trap in an opened configuration of the trap;

FIG. 15 is a top plan view thereof;

FIG. 16 is a cross-section taken in the plane of line 16-16 of FIG. 15;

FIG. 17 is a rear elevation view of the live trap of FIG. 14;

FIG. 18 is a rear elevation view of a sixth embodiment of a live trap; and

FIG. 19 is a rear elevation view of a seventh embodiment of a live trap.

FIG. 20 is a perspective view of another embodiment of a live trap for with the rodent management stations of FIG. 1 and FIG. 38;

FIG. 21 is a top plan view thereof;

FIG. 22 is a front elevation thereof;

FIG. 23 is a cross-section taken in the plane of line 59-59 of FIG. 58;

FIG. 24 is a perspective view of the live trap of FIG. 56 with another embodiment of a trap mechanism positioned therein;

FIG. 25 is a front elevation thereof;

FIG. 26 is a cross-section taken in the plane of line 62-62 of FIG. 61;

FIG. 27 is a perspective view of the live trap of FIG. 56 with another embodiment of a trap mechanism positioned therein;

FIG. 28 is a front elevation thereof;

FIG. 29 is a cross-section taken in the plane of line 65-65 of FIG. 64;

FIG. 30 is a rear perspective view of the live trap of FIG. 56;

FIG. 31 is a rear elevation thereof;

FIG. 32 is a right side elevation thereof;

FIG. 33 is a perspective view of a bottom portion of the live trap of FIG. 56;

FIG. 34 is a top view thereof; and

FIG. 35 is a side elevation thereof.

### DETAILED DESCRIPTION

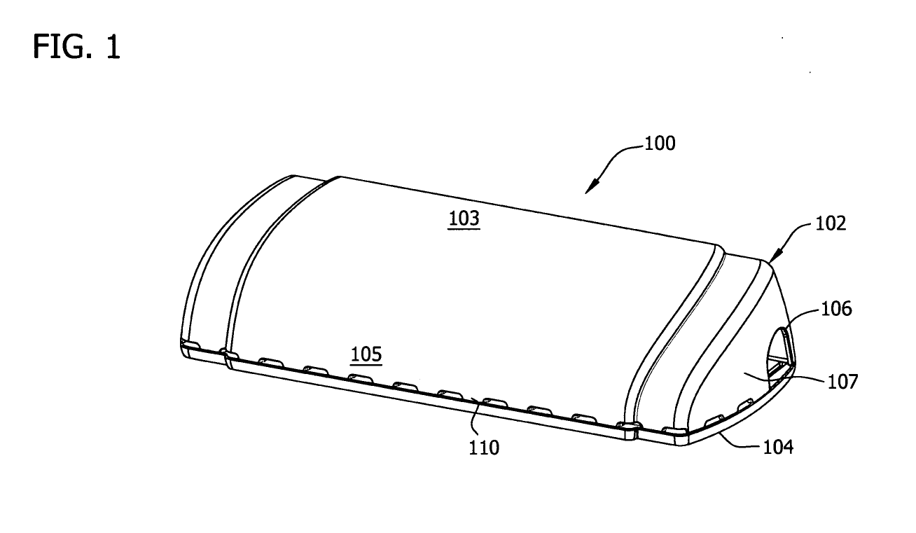

Referring now to the drawings and in particular to FIG. 1, one embodiment of a live trap is indicated generally at 100. The live trap 100 is a multi-sided structure comprising a lid 102 and a base 104 that together broadly define a front, rear, top, bottom and longitudinally opposite sides of the trap, as well as an interior chamber or space 109 of the trap. At least one and more suitably two openings 106 are formed therein in open communication with the interior chamber 109 to provide access thereto. In the illustrated embodiment, for example, a pair of longitudinally opposite notches are formed in the lid 102 such that in a closed configuration of the trap (with the lid down against the base 104), the notches and base 104 broadly define the entry openings 106 of the trap. In some embodiments, bait may be placed within the live trap 100 to attract rodents into the trap.

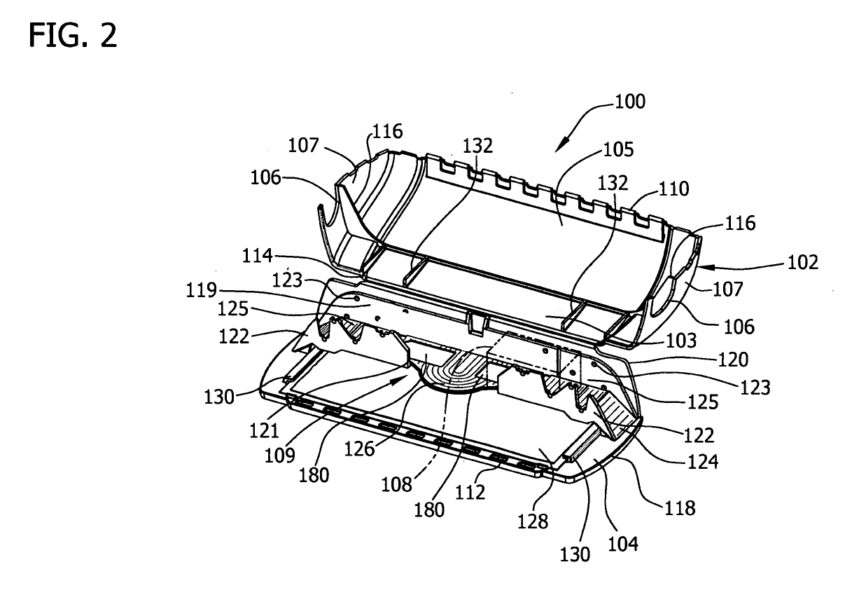

The illustrated lid 102 has a top 103, broadly defining the top of the trap 100, a front 105 broadly defining the front of the trap, and longitudinally opposite sides 107 broadly defining the sides of the trap in the closed configuration of the trap. The base 104 has a bottom panel 118 broadly defining the bottom of the trap 100 and an upstanding (e.g., vertical) rear wall 120 broadly defining the rear of the trap. The top 103 of the lid 102 is suitably hinged to the top of the rear wall 120 of the base 104 to permit pivoting movement of the lid 102 between an opened configuration (FIG. 2) of the trap in which the interior chamber 109 of the trap is accessible, and a closed configuration (FIG. 1) of the trap. Access to the interior chamber 109 of the trap 100 in the opened configuration thereof permits maintenance such as, without limitation, inspecting the trap, changing or replacing trap mechanisms, upgrading trap mechanisms, removing trapped rodents, and clearing debris from the trap.

In the illustrated embodiments, the lid 102 is hinged to the base 104 such as by a living hinge 114 in which a continuous piece of material connects the lid and base. It is understood, however, that a mechanical hinge or other suitable hinge configuration may be used to permit pivoting movement of the lid 102 between the opened and closed configurations of the trap while maintaining connection of the lid 102 with the base 104 to inhibit loss of the lid 102 during servicing. It is also understood that the lid 102 may be attached to the base 104 other than by the hinge 114 and remain within the scope of this invention. In other embodiments the lid 102 may be entirely separable from the base 104 without departing from the scope of this invention. It is further contemplated that the rear of the live trap 100 may instead be defined by a rear panel (not shown) depending from the top of the lid whereby the base instead comprises a relatively flat panel with no upstanding walls. This provides a relatively flat surface that is free from obstructions, thus facilitating easy removal of debris from the live trap 100.

The base 104 and lid 102 according to one embodiment are suitably constructed of a plastic material. In particularly suitable embodiments the lid 102 and base 104 are formed integrally in an injection molding process used for producing parts from thermoplastic or thermosetting plastic materials. It is understood, however, that the lid 102 and base 104 may be constructed of metal or other suitable materials, and that the lid and base may be constructed of different materials from each other, without departing from the scope of this invention.

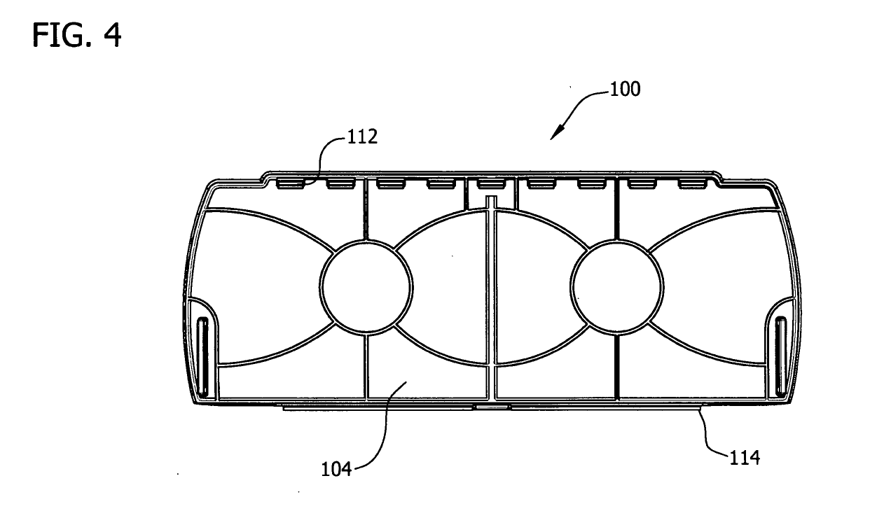

In the illustrated embodiment, the lid 102 is releasably secured to the base 104 other than at the hinged connection therebetween in the closed configuration of the live trap 100. A latch-type fastening system comprises multiple latch detents 110 spaced from each other along the front edge of the lid 102. Receiving slots 112 are disposed in the bottom panel 118 in correspondence with the detents 110 for receiving the detents therethrough in the closed configuration of the trap 100 such that the latch detents generally latch against the underside of the bottom panel 118 as illustrated in FIGS. 1 and 4. The lid 102 may be opened by generally pushing the front of the lid inward (e.g., toward the rear wall 120) relative to the base 104 to unlatch the detents 110 from the bottom panel 118 and allow the detents to move back through the slots 112. The spacing between detents 110 defines openings when the lid is closed against the base for ease of inspection of the interior of the live trap 100 without separating the lid from the base. A technician is able to view the interior of the live trap 100 through these openings to determine whether a rodent or other pest is trapped within the live trap. Additionally, the openings permit pheromones, attractants, or other odors emitted by a trapped rodent to travel from the interior of the live trap 100 to the area surrounding the live trap.

The bottom panel 118 and rear wall 120 of the base are suitably formed integrally, such as by molding them as a single piece, although the bottom panel 118 and rear wall 120 may instead be formed separate and joined together by any suitable attachment technique. In operation, the bottom panel 118 is positioned in a generally horizontal position relative to an underlying surface and the rear wall 120 is perpendicular and abuts a wall or other upstanding surface. The rear wall 120 and bottom panel 118 are of approximately equal length.

A bridge assembly 121 is seated on the bottom panel 118 adjacent to the rear wall 120 for supporting the trap mechanisms of the trap above the bottom panel of the trap. The bridge assembly 121 comprises an outer panel 119 extending up from the bottom panel 118 of the base 104, a pair of longitudinally spaced inner panels 122 in opposed, spaced relationship with the outer panel, and a pair of inclines 124 longitudinally spaced from each other and each interconnecting a respective one of the inner panels with the outer panel of the bridge assembly. The bridge assembly 121 including the inner panels 122, the outer panel 119 and the inclines 124, support a raised platform 126 above the inner surface of the bottom panel 118 (broadly, the floor of the trap 100) within the interior chamber of the live trap, as well as one or more trap mechanisms as described in further detail later herein.

In particular, each of the inner panels 122 has a series of openings (FIG. 2) therein and a groove (not shown) disposed in the rearward (i.e., rear wall 120) facing surface of the inner panel 122. A corresponding set of openings 123 and a groove 125 is formed in the outer panel 119 as illustrated in FIG. 2 to permit modular interchanging of various trap mechanisms into and out of the live trap 100. The platform 126 extends from each of the opposed inclines 124 and runs the width of the live trap 100. The platform is suitably removable from the bridge assembly 121, such as by resting thereon or being releasably mounted thereon, to permit interchanging of various platform 126 designs. Different live trap mechanisms, as discussed below, may be inserted into or formed integrally with the platform for conjoint removal from or placement in the live trap. In this manner, different live trap mechanisms and corresponding platforms may be easily inserted and removed from the live trap 100. Furthermore, in some embodiments the platform 126 may be omitted such that a rodent entering the trap falls or steps directly to the floor of the trap after passing through the live trap mechanism 108. Moreover, in some embodiments the platform may have a pair of windows 180 disposed beneath all or a portion of the live trap mechanism 108 positioned in the bridge assembly 121. The pair of windows 180 are sized and shaped to permit a rodent to pass therethrough. A rodent is thus prevented from travelling in between the live trap mechanism 108 and the platform 126 and interfering with the operation of the live trap mechanism.

The longitudinally opposite inclines 124 or other suitable guide structure such as stairs, are disposed at the opposite ends of the platform 126. In particular, the inclines 124 lead from the bottom panel 118 adjacent the respective entry openings 106 upward to the platform 126 such that rodents entering the live trap 100 at the entry openings 106 are guided up the inclines to the platform 126. Where the platform is omitted, the inclines 124 lead the rodent directly to the trap mechanism 108. The inner panels 122 along with the outer panel 119 and lid 102 which is in close proximity to the bridge assembly 121 in the closed configuration of the live trap inhibit the rodent from moving in a direction other than up the incline 124.

As illustrated in FIG. 2, the platform 126 extends longitudinally substantially the length of the rear wall 120 above the inner surface of the bottom panel 118 of the base. A longitudinal gap is provided between the inner panels 122 where the platform 126 opens to a trap chamber 109 in which the rodents step down onto the bottom panel 118 and become trapped within the live trap. In some embodiments, the platform 126 extends outward relative to the rear wall 120 approximately one-half the distance from the rear wall 120 to the front edge of the bottom panel 118 of the base 104. It is understood, however, that this distance may vary depending on the desired size of the live trap 100. It is also contemplated that one or more openings may be formed in the platform 126 so that a rodent may step down through the opening in the platform onto the floor of the trap instead of stepping off the platform at the gap between the inner panels 122. An adhesive pad 128, such as a glue board, covers at least a portion and more suitably most of the inner surface of the bottom panel 118 to inhibit movement of the rodent within the trap chamber 109. In one particular embodiment, the adhesive pad 128 covers an area of the trap chamber generally away from the platform 126 so that rodents can move freely away from the platform and then have reduced mobility once away from the platform so that the rodent is inhibited against getting stuck below the platform.

In other embodiments, the adhesive pad 128 may cover portions of the bottom panel 118 beneath the platform 126. The adhesive pad 128 is suitably non-adherent to the inner surface of the bottom panel 118, thus rendering it easily removable from the trap 100 for replacement. The adhesive used to coat the adhesive pad 128 is of a suitable composition to securely bind a rodent that comes into contact therewith to the pad. Different types of adhesives and glues may be used according to embodiments of the invention. In addition, some embodiments of the invention may not implement an adhesive pad 128. Pad guides 130 are positioned on the bottom panel 118 to properly locate the adhesive pad on the bottom panel 118. The pad guides 130 are spaced approximately the same distance apart as the width of the adhesive pad 128 so that the pad 128 is generally constrained from lateral movement within the trap. As the adhesive pad 128 resides, in part, under the platform 126 significant space savings are realized. When the rodent exits a live trap mechanism 108 and the bridge assembly 121, as described below, the rodent comes into contact with the adhesive pad 128.

Common to the embodiments, regardless of whether they utilize the platform 126, is the increased force with which a rodent contacts the adhesive pad 128. This increase results from the fall or downward movement the rodent experiences upon exiting or falling from the live trap mechanism 108 or platform 126 down onto the adhesive pad 128. The downward motion results in the rodent coming into contact with the adhesive pad 128 with greater force, thus improving the bond between the rodent and the adhesive pad. The rodent is unable to lightly tread upon the adhesive pad 128 (e.g., a rodent is not able to retreat from the adhesive pad 128 after coming into contact therewith).

The lid 102 contains integrally formed lateral webs 116 connecting the sides of the lid with the top of the lid. In the closed configuration of the trap (with the lid closed) the webs 116 extend into closely spaced relationship with the inner surface of the bottom panel 118 of the base 104 to further form a passageway that extends from the entry openings 106 up the inclines 124 and along the platform 126 within the live trap 100. In alternative embodiments, suitable web or other panel structure may be formed separate from the lid 102 and attached thereto to facilitate forming the passageway when the lid is closed. The webs 116 also increase the structural rigidity of the lid 102. The lid further includes a plurality of ribs 132 depending from the inner surface of the lid 102. These ribs 132, like the interior panels 116, may be formed integrally with the lid 102, or alternatively fabricated as separate pieces and attached to the inner surface of the lid 102. The ribs 132 add structural rigidity to the lid 102.

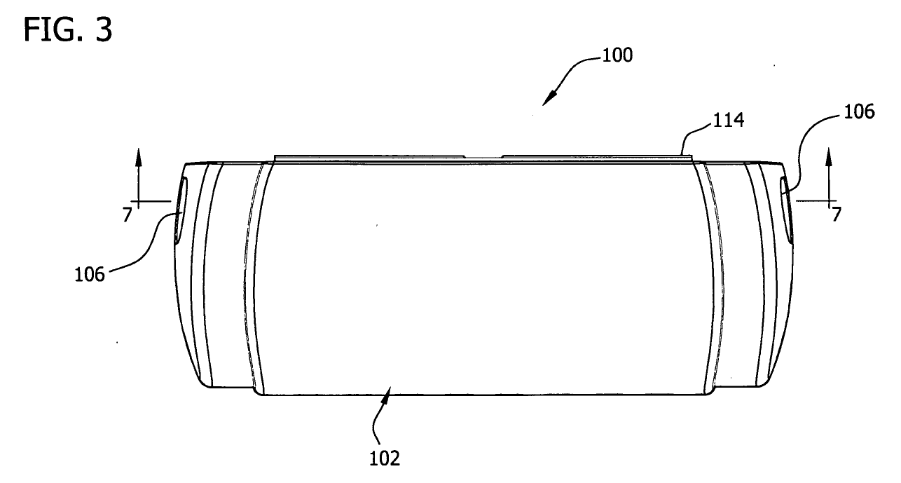

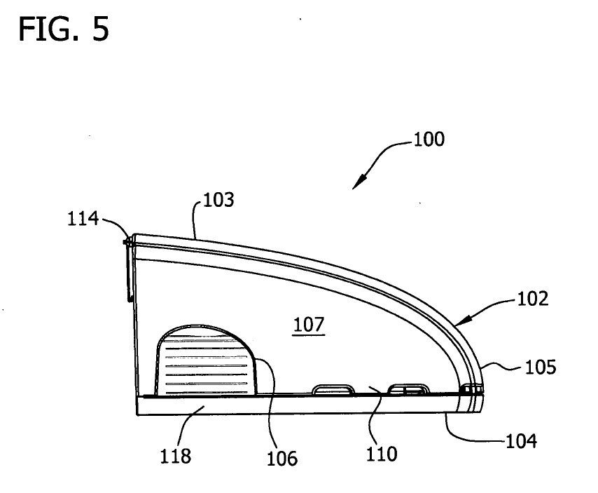

As seen in the top plan view of FIG. 3, the base 104 and lid 102 are substantially similar in their length and width, although either the lid 102 or base 104 may have a slightly larger or smaller length or width without departing from the scope of the embodiments. As seen in the front elevation view of FIG. 4 and the side elevation view of FIG. 5, the height of the live trap 100 may vary over its length and width with the height decreasing toward the front of the trap. This sloping profile of the lid 102 facilitates drainage of water, ice, or snow from the surface of the lid 102, thus preventing it from stagnating. Furthermore, the sloping profile increases the structural strength of the trap and increases its resistance to damage from falling objects, as they are more likely to be deflected.

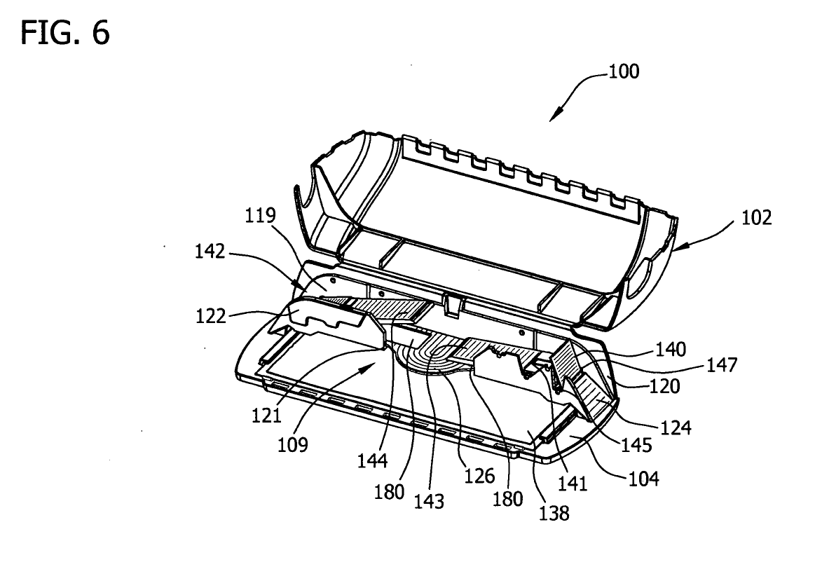

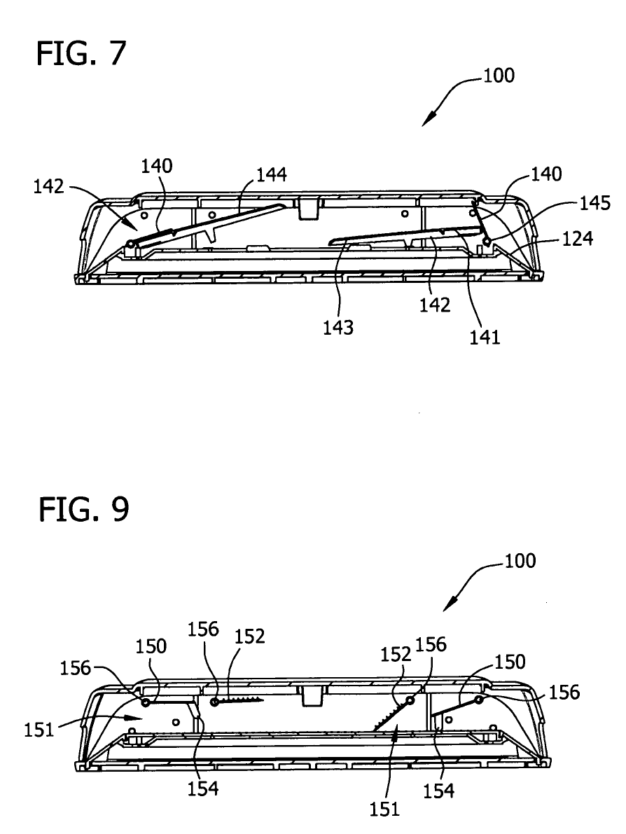

A variety of suitable trap mechanisms are contemplated according to various embodiments of the invention to trap rodents within the trap chamber of the live trap 100. For example, in one embodiment illustrated in FIGS. 6 and 7 a pair of ramp-type trap mechanisms 142 are provided within the live trap 100. The ramp-type trap mechanism 142 depicted on the left side of FIG. 6 is in an un-sprung position, as it would be before a rodent came into contact therewith. The trap mechanism 142 on the right side is in a sprung position as would occur as a rodent walks on the mechanism toward its exit end 143. Each ramp-type trap mechanism 142 comprises a ramp 144 extending longitudinally along the platform 126 between the inner panel 122 and outer panel adjacent a respective end of the platform. The ramp 144 has an entry end 141 nearest the entry opening 106 and the exit end 143 further from the entry opening. The ramp 144 is mounted on the platform 126 for pivoting movement between the position illustrated by the left-side trap in FIG. 6 and the position illustrated by the right-side trap in FIG. 6. A trap door 140 is pivotally mounted on the bridge assembly 121 generally adjacent the entry end 141 of the ramp by a suitable pivot pin 145. This pivot pin 145 seats within one set of corresponding openings 147 in the inner panel 122 and outer panel 119 of the bridge assembly as seen best in FIG. 6. A spring, weight or other device (not shown) is used to bias the ramp in a position in which the ramp 144 slants upwards from the entry end 141 to the exit end 143 thereof as illustrated on the left hand side of FIG. 6. In this position, the trap door 140 lays generally flat against the ramp 144 to permit a rodent that enters the trap proceed up the ramp over the trap door.

As the rodent proceeds past the trap door 140, the weight of the rodent causes the ramp 144 to pivot downward (i.e. to pivot the exit end downward). This pivoting of the ramp 144 causes the entry end 141 of the ramp to rise, pushing the trap door 140 to pivot about the pin 145 to an upright position as illustrated on the right hand side of FIGS. 6 and 7 thus preventing the rodent from turning around and exiting the trap. One of the ribs 132 descending from the lid acts as a stop for the trap door as it moves to its upright position. The rodent must therefore continue further along the ramp and onto the platform 126 (or onto the floor where the platform is omitted). Once the rodent is off of the ramp 144, the ramp returns to its initial position with the trap door 140 again laying generally flat against the ramp. The rodent subsequently steps off of the platform 126 onto the adhesive pad 138 covering the bottom panel 118 of the base within the trap chamber 109 to inhibit further movement of the rodent.

As described previously, in other embodiments one or more openings (not shown) may be present in the platform 126 adjacent to the exit end 143 of each ramp 144 such that when the rodent steps from the exit end of a ramp it may step down through the opening in the platform 126 and come into contact with the adhesive pad 128. For example, a rodent would proceed from the exit end 143 of the ramp 144 and continue to travel across the platform, towards the ramp on the opposing side of the platform 126. Assuming that another rodent was not present on the opposing side of the platform 126, the rodent would come into contact with the opening, thus falling or stepping down through it onto the adhesive pad 138 positioned beneath. By the rodent falling through the openings in the platform 126, they are thus prevented from becoming lodged underneath the ramps 144 and preventing their intended operation.

In other embodiments, an adhesive pad 138 may not be used. The rodent would then fall or step down through holes formed in the platform 126 after proceeding off of the ramp and is then free to move unencumbered within the live trap 100. Alternatively, a platform 126 may not be used. In such an embodiment, a rodent would fall to the floor of the live trap 100 after proceeding off of the exit end 143 of the ramp 144.

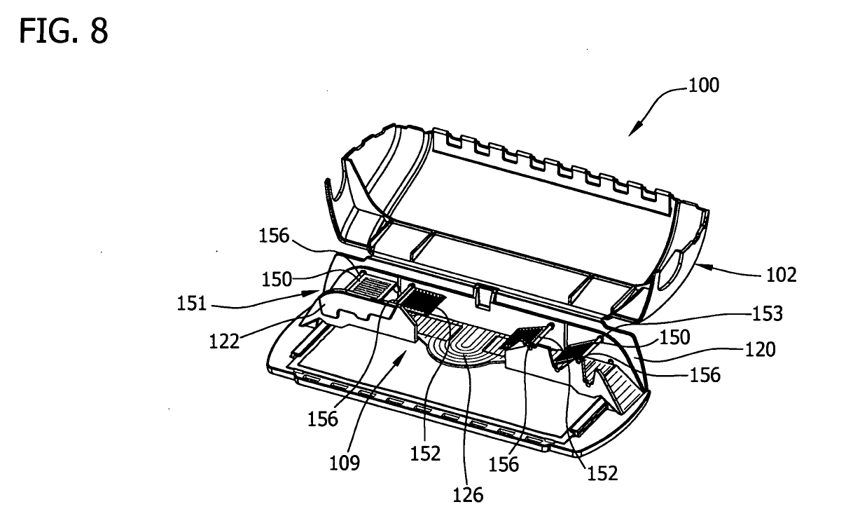

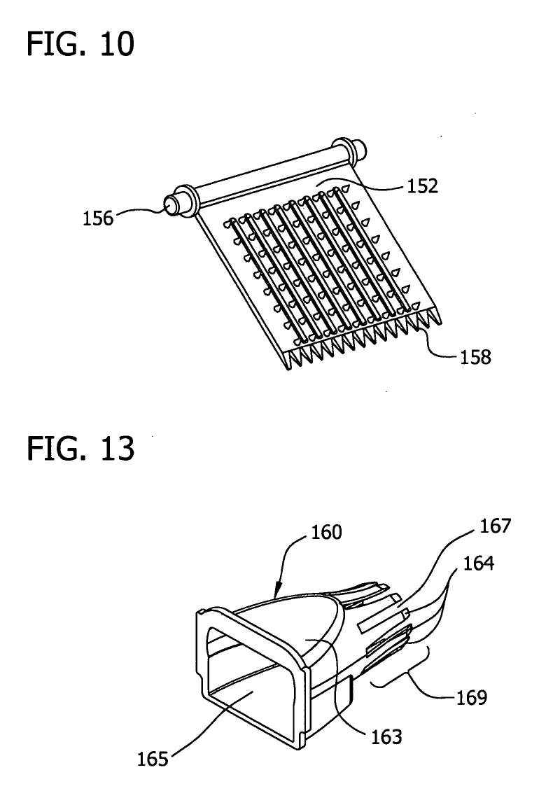

FIGS. 8-10 illustrate another trap mechanism, referred to herein as a swing door trap mechanism 151. The swing door trap mechanism 151 comprises a swing door 152 that is pivotably supported by a pivot pin 156 that seats within corresponding openings 153 in the inner panel 122 and rear wall 120 as seen best in FIG. 8. The swing door 152 may contain slots formed therein across its width to permit light or odors to more easily travel therethrough, or the swing door may be of a generally solid construction. The pivot pin 156 may comprise an elongate pin extending through a tubular member at the top of the swing door, or by nubs extending longitudinally outward from the top of the swing door as in the illustrated embodiment of FIG. 10. The openings 153 in which the pivot pin 156 seat are at a suitable height close to the lid 102 when the lid is closed as illustrated on the right hand side of FIG. 9 so that the rodent cannot climb back over the top of the swing door 152 once it passes the door. The swing door 152 is also suitably sized in length longer than the height of the pivot pin 156 above the platform so that in its initial position it contacts the platform of the trap in a slightly angled orientation of the door 152 as is also illustrated on the right hand side of FIG. 9. In this manner, the door 152 is capable of swinging only one way from its initial position, i.e., inward toward the interior chamber of the trap. In the illustrated embodiment, the swing door 152 also has teeth 158 positioned along its free edge as well as along its surface. In some embodiments (not shown) the swing door 152 may have slots formed therein.

As the rodent enters the live trap with the swing door trap mechanism 151 they come into contact with the swing door 152 and cause it to rotate upward about the pivot pin 156. If the rodent attempts to retreat from the trap while passing beneath the swing door 152, the teeth 158 at the free end of the swing door 152 bite into the rodent to discourage such rearward movement. After the rodent has cleared the swing door 152, the door pivots back to its initial state, thus blocking any retreat by the rodent.

In the illustrated embodiment of FIGS. 8 and 9, an additional swing door 150 positioned in front of the swing door 152 may be provided. The additional swing door 150 may be of the same construction as the swing door 152, or of a different construction. In such an embodiment, the additional swing door 150 does not have teeth, while in other embodiments the additional swing door 150 may have teeth. The additional swing door 150 also comprises a foot 154 that keeps it from resting completely on the floor of the trap, thereby by permitting the rodent to peer underneath it. As the rodent passes underneath the additional swing door 150 they come into contact therewith and are able to easily retreat from the trap as there are no teeth on the free end of the additional swing door, according to some embodiments. The rodent is encouraged by this additional swing door 150 that it is capable of retreat and to thus continue through the next door, which is the swing door 152. Additionally, the rodent is encouraged that since it is capable of pushing open the additional swing door 150 it will likewise be able to push open the swing door 150.

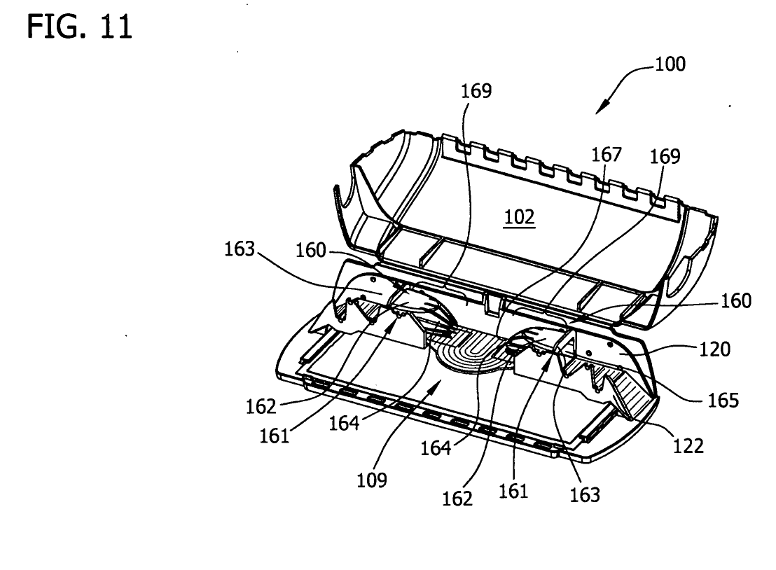

With reference now to FIGS. 11-13, a third trap mechanism is illustrated and referred to herein as a funnel trap mechanism 161 comprising a funnel 160 that sits in the passageway along the platform between the inner panel and the rear wall 120. A collar 163 surrounds (i.e., extends outward from) the funnel 160 and is sized in width to seat within the opposed grooves disposed in the inner panel 122 and rear wall 120 to properly locate and retain the funnel on the platform 126. Alternatively, the funnel trap may be integrally formed with the platform 126, with the inner and/or outer panels of the bridge assembly 121 and/or with other components of the bridge assembly.

The funnel 160 has a first or entry end 165 nearest the entry opening 106 of the trap and an exit end 167 more distal from the entry opening. The funnel 160 more suitably comprises a rigid segment 162 extending longitudinally downstream from the entry of the funnel 160 and a flexible segment 169 comprising a plurality of fingers 164 attached to and extending longitudinally downstream from the rigid segment 162 of the funnel 160 to the exit end thereof. The rigid segment 162 of the illustrated funnel 160 is generally cylindrical or rectangular in shape with a constant inner cross-sectional area along its length. Although it is understood that the rigid segment 162 may be shaped other than cylindrical or rectangular, and be of non-uniform inner cross-section, without departing from the scope of this invention.

The fingers 164 are configured to angle inward (relative to the centerline of the funnel 160) toward each other such that the exit end 167 of the funnel is substantially narrower than the entry end 165 of the funnel. The fingers 164 are suitably flexible and resilient to permit outward bending of the fingers 164 against the bias thereof as the rodent passes through the flexible segment 169 of the funnel 160 to the exit end 167 of the funnel. As a rodent moves through the exit end 167 of the funnel 160, the bias of the fingers 164 causes the tips of the fingers to remain in contact with the body of the rodent. If the rodent tries to reverse course, the tips of the fingers 164 dig into or otherwise apply pressure to the rodent, thereby encouraging the rodent to continue moving forward past the funnel 160 to the trap chamber. Once the rodent exits the funnel 160, the fingers 164 return to their initial position, rendering the exit end 167 of the funnel too narrow for the rodents head to fit through so the rodent cannot move back through the funnel. Furthermore, if a rodent attempts to enter the exit end 167, the fingers 164 of the funnel 160 flex inward, pressing into the rodent's head and thus preventing it from exiting the live trap 100 through the funnel.

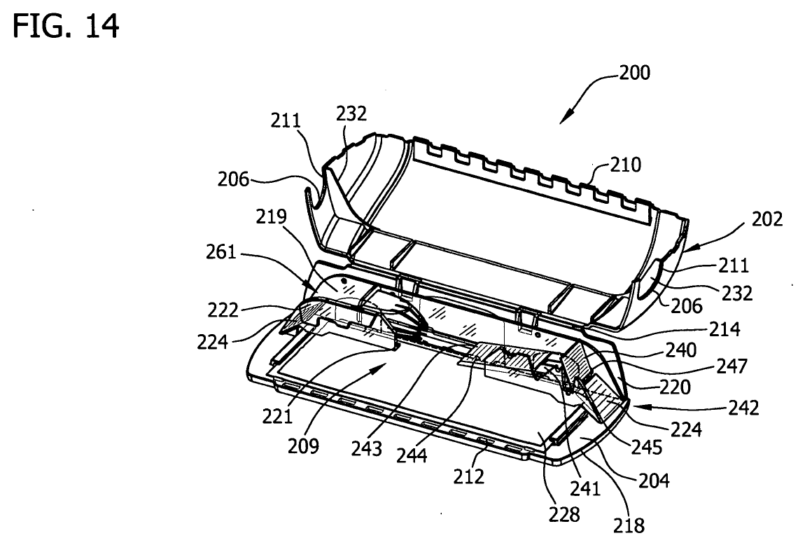

With reference now to FIGS. 14-19 and in particular FIG. 14, another embodiment of a live trap is indicated generally at 200. Like the live trap 100, the live trap 200 is a multi-sided structure comprising a lid 202 and a base 204, together broadly defining a “housing” having a front, rear, top, bottom and longitudinally opposite sides, as well as an interior chamber or space 209. At least one and more suitably two openings 206 are formed therein in open communication with the interior chamber 209 to provide access thereto. In the illustrated embodiment, for example, a pair of longitudinally opposite notches 211 are formed in the lid such that in a closed configuration of the trap (with the lid 202 down against the base 204), the notch and base broadly define the entry openings 206 of the trap. In some embodiments, bait may be placed in the interior chamber 209 to attract rodents into the live trap 200.

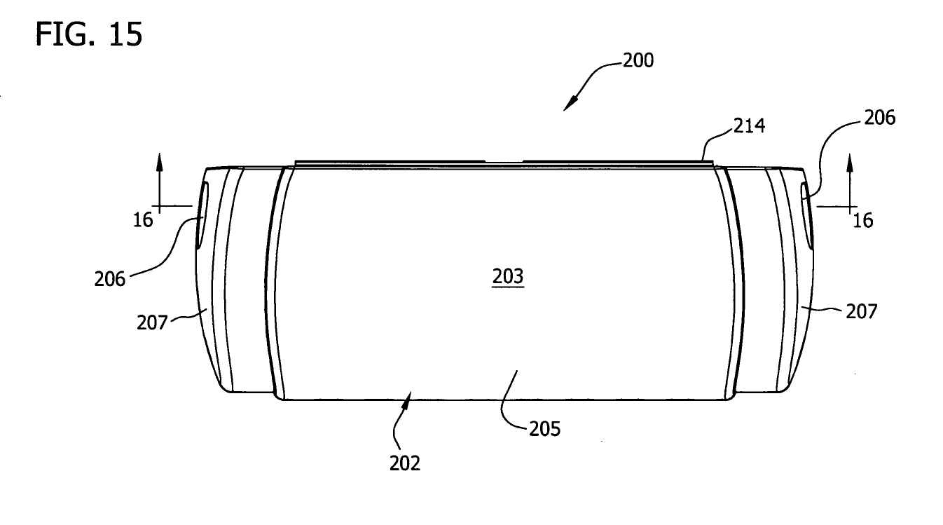

The illustrated lid 202 has a top 203, broadly defining the top of the trap 200, a front 205 broadly defining the front of the trap, and longitudinally opposite sides 207 broadly defining the sides of the trap in the closed configuration of the trap. The base 204 has a bottom panel 218 broadly defining the bottom of the trap 200 and an upstanding (e.g., vertical) rear wall 220 broadly defining the rear of the trap. The top 203 of the lid 202 is suitably hinged to the top of the rear wall 220 of the base 204 to permit pivoting movement of the lid 202 between an open configuration (FIG. 14) of the trap in which the interior chamber 209 of the trap is accessible, and a closed configuration (FIG. 15) of the trap. Access to the interior chamber 209 of the trap 200 in the open configuration thereof permits maintenance such as, without limitation, inspecting the trap, changing or replacing trap mechanisms, upgrading trap mechanisms, removing trapped rodents, and clearing debris from the trap.

The live trap 200 has at least one inspection member. In one suitable embodiment, the inspection member may be a translucent or transparent window, while in another suitable embodiment the inspection member may be one or more slots formed in the live trap 200. Furthermore, while the inspection member is illustrated in FIGS. 14-19 as being positioned in the rear wall 220 of the base 204, the inspection member may be suitably located in the bottom panel 218 of the base or in the lid 202.

In the illustrated embodiment of FIGS. 14-17, the live trap 200 has inspection members in the form of transparent windows, i.e., a first viewing window 302 and a second viewing window 304. The windows 302, 304 may be positioned over corresponding openings formed in the rear wall 220 of the base 204. Alternatively, the composition of the rear wall 220 may vary, such that the windows 302, 304 have a transparent or translucent configuration. The windows 302, 304 permit viewing and visual inspection of the interior chamber 209 of the live trap 200 from the exterior of the trap. Accordingly, the interior chamber 209 of the live trap 200 is viewable through the windows 302, 304 without opening the trap. Although not shown, a removable cover may be provided to cover the windows 302, 304 and prevent the viewing therethrough of the interior chamber 209 of the live trap 200. The removable cover may be positioned on the exterior of the windows 302, 304, away from the interior chamber 209, such that they are easily removed by a technician desiring to inspect the interior chamber of the live trap 200. The removable cover thus prevents the unauthorized or unintended viewing of the interior chamber 209. The removable cover may be a single, unitary cover or corresponding removable covers may be provided for each of the windows 302, 304. Moreover, removable covers may be provided for any of the inspection members.

The windows 302, 304 may be formed from any suitable transparent or translucent material (e.g., transparent or translucent plastic, polycarbonate resin thermoplastic, acrylic glass, or glass). The windows 302, 304 are coupled to the lid 202 of the live trap 200 by adhesive or other suitable fastening mechanisms. The windows 302, 304 are positioned over corresponding openings formed in the lid 302. While two windows 302, 304 are shown in the illustrated embodiment, any number of windows are contemplated without departing from the scope of the embodiments. Moreover, the placement and/or dimensions of the windows 302, 304 may be altered without departing from the scope of the embodiments.

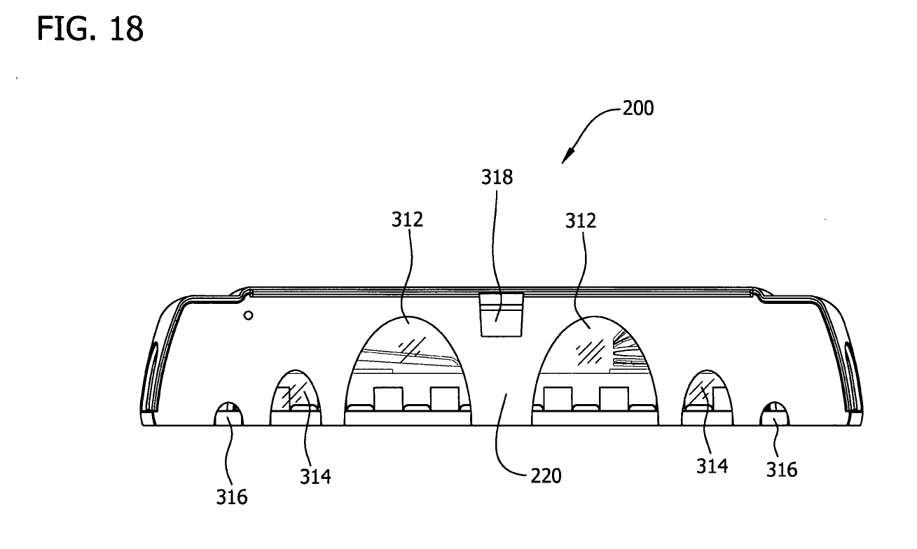

FIG. 18 illustrates another embodiment of the inspection members similar to the windows 302, 304 of FIGS. 14-17. A first pair of arch-shaped windows 312 are positioned generally near the center of the rear wall 220. A second pair of arch-shaped windows 314 are outwardly positioned from the first pair of windows 312 and have a surface area substantially less than the first pair. A third pair of arch-shaped windows 316 are outwardly positioned from the second pair of windows 314 and likewise have a surface substantially less than both the first pair of windows 312 and the second pair of windows. A center window 318 is positioned between the first pair of windows 318 to further aid in viewing the interior chamber 209 of the live trap 200.

In yet another embodiment, illustrated in FIG. 19, the inspection members comprise a plurality of vertically-oriented slots 320 formed in the rear wall 220 of the base 204. While the slots 320 are shown in a grouped arrangement, any suitable arrangement may be utilized that permits viewing of the interior chamber 209 of the live trap 200. Moreover, in other embodiments the slots 320 are horizontally oriented instead, or in combination with, vertically oriented slots.

In operation, the inspection members (regardless of their form) permit a technician positioned outside of the live trap 200 to view the interior chamber 209 of the live trap. The technician is thus able to inspect the interior chamber 209 without opening the lid 202 and determine the presence of rodents, debris, or other conditions which warrant servicing of the live trap 200. The amount of time required to service the live trap 200 is reduced accordingly; the technician need only open the lid 202 when servicing is required, while under current systems the technician often opens a trap only to discover that the trap is not in need of servicing.

In the illustrated embodiment, the lid 202 is hinged to the base 204 such as by a living hinge 214 in a manner similar to or the same as described above in relation to the living hinge 114 and the live trap 100. The base 204 and lid 202 according to one embodiment are suitably constructed of a plastic material. In particularly suitable embodiments the lid 202 and base 204 are formed integrally in an injection molding process used for producing parts from the thermoplastic or thermosetting plastic materials. It is understood, however, that the lid 202 and base 204 may be constructed of metal or other suitable materials, and the lid and base may be constructed of different materials from each other, without departing from the scope of this invention. While the lid 202 and base 204 of the live trap 200 may be hinged together at or near the rear wall 220, as shown in FIG. 14, in other embodiments the lid and base may be hinged together near the front of the live trap.

In the illustrated embodiment the lid 202 is releasably secured to the base 204 other than at the hinged connection therebetween in the closed configuration of the live trap 200. A latch-type fastening system comprises multiple latch detents 210 spaced from each other along the front edge of the lid 202. Receiving slots 212 are disposed in the bottom panel 218 in correspondence with the detents 210 for receiving the detents therethrough in the closed configuration of the trap 200 such that the latch detents generally latch against the underside of the bottom panel 218 as illustrated in FIG. 14. The lid 202 may be opened by generally pushing the front of the lid inward (e.g., toward the rear wall 220) relative to the base 104 to unlatch the detents 210 from the bottom panel 218 and allow the detents to move back through the slots 212. The spacing between detents 210 define openings when the lid is closed against the base for ease of inspection of the interior chamber 109 of the live trap 200 through these openings to determine whether a rodent or other pest is trapped within the live trap. Additionally, the openings permit pheromones, attractants, or other odors emitted by a trapped rodent to travel from the interior of the live trap 200 to the area surrounding the live trap. The openings also allow insects to enter the station and become trapped on an adhesive pad, thus providing a method for monitoring the presence of insects. The lid further includes a plurality of ribs 232 depending from the inner surface of the lid 202. These ribs 232 add structural rigidity to the lid 202 and serves as partitions or blocking members to prevent or inhibit rodents from travelling over the trap mechanisms and escaping from the live trap 200.

The bottom panel 218 and rear wall 220 of the base are suitably formed integrally, such as by molding them as a single piece, although the bottom panel 218 and rear wall 220 may instead be formed separate and joined together by any suitably attachment technique. In operation, the bottom panel 218 is positioned in a generally horizontal position relative to an underlying surface and the rear wall 220 is perpendicular and abuts a wall or other upstanding surface. The rear wall 220 and bottom panel 218 are of approximately equal length.

A bridge assembly 221 is seated on the bottom panel 218 adjacent to the rear wall 220 for supporting the trap mechanisms of the trap above the bottom panel of the trap. The bridge assembly 221 is formed from a transparent or translucent material having the same or similar composition to that used to form the windows 302, 304. Accordingly, rodents or other debris present beneath the bridge assembly 221 are visible from inspection outside the live trap 200 through the inspection members without opening the lid 202.

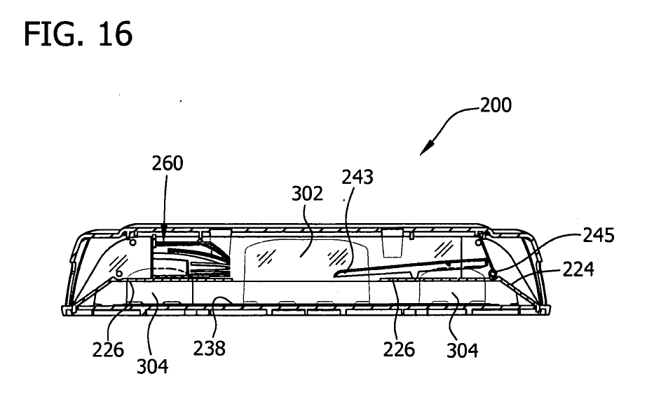

The bridge assembly 221 comprises an outer panel 219 extending up from the bottom panel 218 of the base 204, a pair of longitudinally spaced inner panels 222 in opposed, spaced relationship with the outer panel, and a pair of inclines 224 longitudinally spaced from each other and each interconnecting a respective one of the inner panels with the outer panel of the bridge assembly. The bridge assembly 221 including the inner panels 222, the outer panel 219 and the inclines 224, support one or more trap mechanisms as described above. Unlike the live trap 100 and the platform 126 positioned therein, the trap mechanisms are supported by a horizontal platform 226 (FIG. 16) that does not extend between the two spaced-apart trap mechanisms positioned in the live trap 200. Rather, the panel 226 terminates at or near the exit end of the trap mechanism positioned in the live trap 200 and a rodent exiting the trap mechanism falls directly onto the floor of the live trap or an adhesive pad positioned thereon. Like the bridge assembly 221, the platform 226 may be formed from a transparent or translucent material. The bridge assembly 221 may suitable include one or more partitions positioned underneath to prevent a rodent from travelling underneath the bridge assembly.

Furthermore, the horizontal platform 226 is positioned beneath the trap mechanism and runs from at or near the incline 224 to at or near the exit end of the one or more trap mechanisms. Accordingly, the rodent does not come into contact with the horizontal platform 226 after exiting the trap mechanism positioned in the live trap 200 and instead falls or steps from the elevated position of the trap mechanism to the bottom panel 218 of the live trap. An adhesive pad 228 is positioned on the bottom panel 218 in a manner similar to that of the adhesive 128 described above. The rodent thus falls onto the adhesive pad 228 after exiting the trap mechanism.

The bridge assembly 221 includes one or more releasable fasteners permitting the bridge assembly to be selectively coupled to either of the rear wall 220 or the bottom panel 218. The releasable fasteners may be snap fasteners, hook and loop fasteners, or any other suitable fastener. The bridge assembly 221 may thus be easily removed from the live trap 200 and replaced with another, differently configured bridge assembly. Removing the bridge assembly 221 from the live trap 200 facilitates servicing of the live trap. Rodents or other material (collectively, “debris”) may accumulate in between the bottom panel 218 and the bridge assembly 221. By removing the bridge assembly 221, the accumulated debris is more easily removed by sweeping clean the relatively flat, unobstructed surface beneath the bridge assembly. After removal of the debris, the bridge assembly 221 is suitably placed in the live trap 200.

The longitudinally opposite inclines 224 or other suitable guide structure such as stairs, are disposed at the opposite ends of the horizontal platform 226. The inclines 224 function in a manner similar to the inclines 124 described above, and guide rodents entering the live trap 200 at the entry openings 206 up to the horizontal platform 226 or the trap mechanism.

Common to the embodiments, regardless of whether they utilize the platform 126 or horizontal platform 226, is the increased force with which a rodent contacts the adhesive pad 128 or 228. This increase results from the fall or downward movement the rodent experiences upon exiting or stepping off of the live trap mechanism 208 or platform 226 to the adhesive pad 128 or 228. The downward motion results in the rodent coming into contact with the adhesive pad 128 or 228 with greater force, thus improving the bond between the rodent and the adhesive pad. The rodent is unable to lightly tread upon the adhesive pad 128 or 228 (e.g., a rodent is not able to retreat from the adhesive 228 after coming into contact therewith).

As described above in relation to FIGS. 6-13, a variety of suitable types of trap mechanisms are contemplated according to various embodiments of the invention to trap rodents within the trap chamber of the live trap 100 and 200. The trap mechanisms of FIGS. 6-13 are suitable for use in the live trap 100 as well as the live trap 200. In the embodiments shown in FIGS. 14-19, rodents exiting the trap mechanisms into the interior chamber 209 fall or step directly onto the adhesive pad 228 and generally do not come into contact with the horizontal platform 226. In some embodiments (not shown) the horizontal platform 226 extends out some distance from the exit end of the trap mechanism and the rodent thus travels along at least a portion of the horizontal platform 226 before falling therefrom onto the adhesive pad 228 and/or bottom panel 218. Moreover, in these embodiments wherein the horizontal platform 226 extends out some distance from the exit end of the trap mechanism, a portion (e.g., a window) of the horizontal platform 226 directly beneath all or a portion of the trap mechanism may be removed or have openings formed therein. The removed portion or openings are sized and shaped to permit a rodent to pass therethrough. A rodent is thus prevented from travelling in between the trap mechanism and the horizontal platform 226 and interfering with the operation of the trap mechanism.

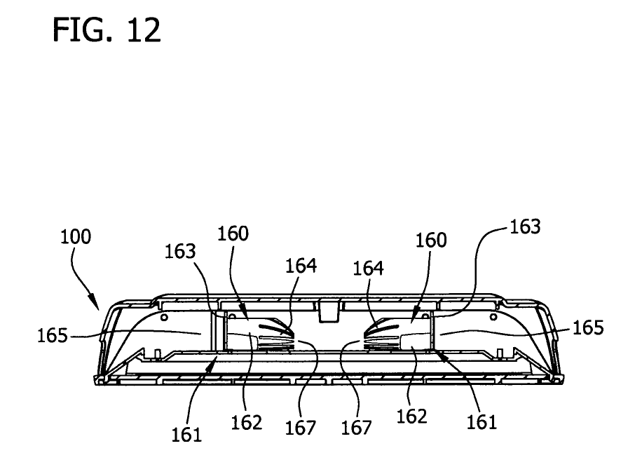

As shown in FIGS. 14 and 16, a ramp-type trap mechanism 242 and a funnel trap mechanism 261 are provided within the live trap 200. The funnel trap mechanism 261 has a first or entry end 165 nearest the entry opening 206 of the trap and an exit end 267 more distal from the entry opening. The funnel trap mechanism 261 is similar in design and function to that shown in FIGS. 11 and 12 and may likewise use a similar arrangement of the panel 226 such that open a rodent exiting the funnel trap mechanism into the interior chamber 209 the rodent falls directly onto the floor of the live trap or an adhesive pad positioned thereon.

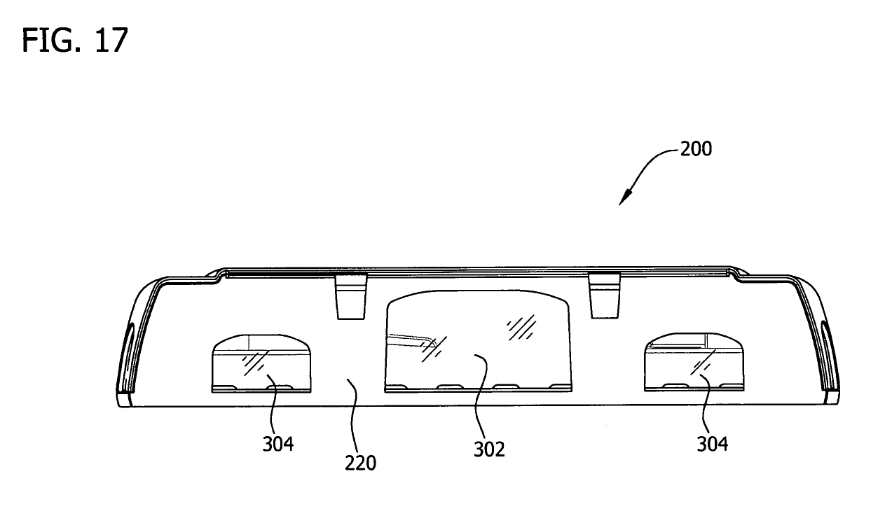

The ramp-type trap mechanism 242 illustrated in FIGS. 14 and 16 is in a sprung position as would occur as a rodent walks on the mechanism toward its exit end 243. Each ramp-type trap mechanism 242 comprises a ramp 244 extending longitudinally along the horizontal platform 226 between the inner panel 222 and outer panel adjacent a respective end of the panel. The ramp 244 has an entry end 241 nearest the entry opening 206 and the exit end 243 further from the entry opening. The ramp 244 is mounted on the panel 226 for pivoting movement between the position illustrated by the left-side trap in FIG. 17 and the position illustrated by the right-side trap in FIG. 17. A trap door 240 is pivotally mounted on the bridge assembly 221 generally adjacent the entry end 241 of the ramp by a suitable pivot pin 245. This pivot pin 245 seats within one set of corresponding openings 247 in the inner panel 222 and outer panel 219 of the bridge assembly as seen best in FIG. 16. A spring, weight or other device (not shown) is used to bias the ramp in a position in which the ramp 244 slants upwards from the entry end 241 to the exit end 243 thereof as illustrated on the left hand side of FIG. 17. In this position, the trap door 240 lays generally flat against the ramp 244 to permit a rodent that enters the trap proceed up the ramp over the trap door.

As the rodent proceeds past the trap door 240, the weight of the rodent causes the ramp 244 to pivot downward (i.e. to pivot the exit end downward). As seen best in FIG. 17, the exit end 243 of the ramp 244 is able to pivot downward and contact the adhesive pad 238. Unlike the embodiment described in relation to FIGS. 6 and 7 above, the downward movement of the exit end 243 of the ramp 244 is not restricted by the panel 226. The rodent is thus able to travel directly onto the floor of the live trap 200 or an adhesive pad positioned thereon.

This pivoting of the ramp 244 causes the entry end 241 of the ramp to rise, pushing the trap door 240 to pivot about the pin 245 to an upright position as illustrated on the right hand side of FIGS. 16 and 17 thus preventing the rodent from turning around and exiting the trap. One of the ribs (similar to the ribs 132 described above in FIG. 2) descending from the lid 202 acts as a stop for the trap door 240 as it moves to its upright position. The rodent must therefore continue further along the ramp 244 and onto the floor or an adhesive pad positioned thereon. Once the rodent is off of the ramp 244, the ramp returns to its initial position with the trap door 240 again laying generally flat against the ramp.

A trap mechanism similar to that described in FIGS. 8 and 9 may suitably be used in the live trap 200. However, according to one embodiment only a single swing door may be utilized. This single swing door may be similar in construction either the additional swing door 150 or the swing door 152 (both shown in FIGS. 8 and 9). Furthermore, the panel 226 terminates at or near a position such that upon a rodent passing through the single swing door into the interior chamber 209 of the live trap 200 falls directly onto the floor of the live trap or an adhesive pad positioned thereon.

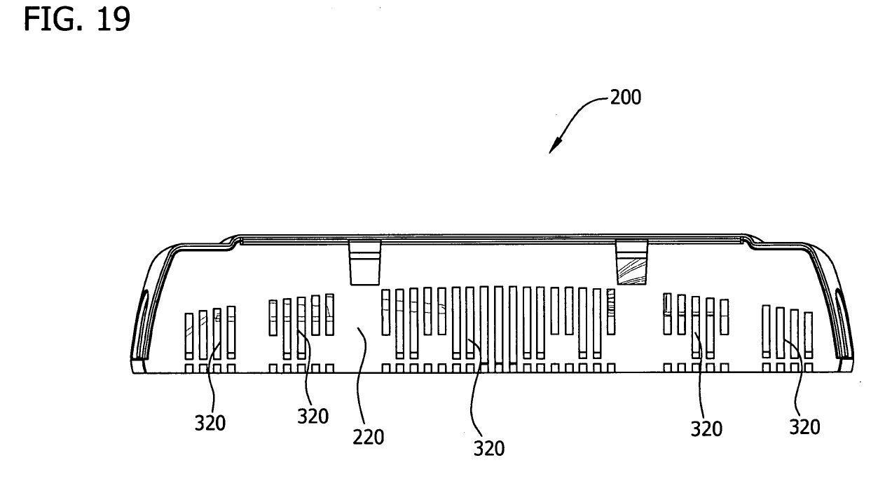

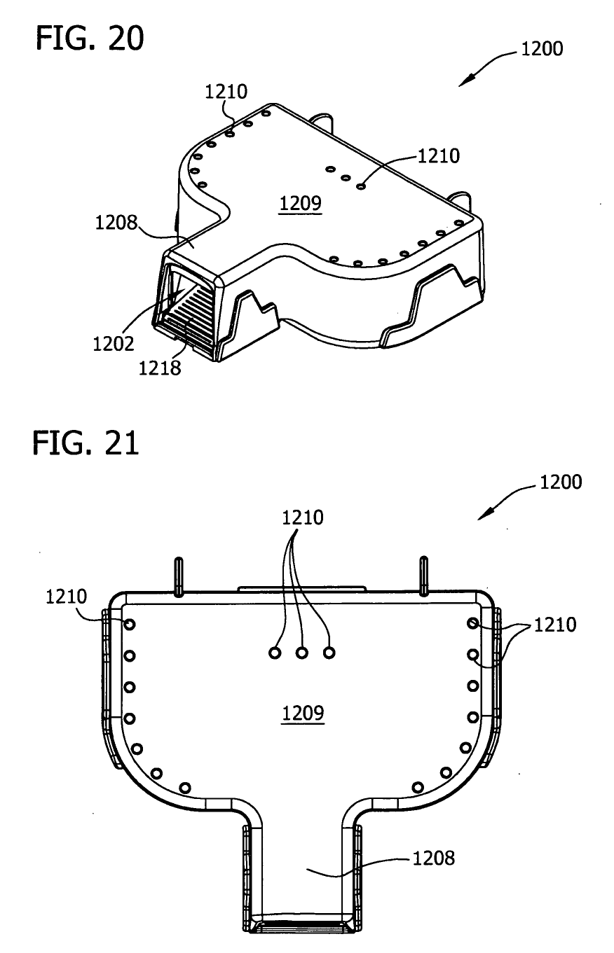

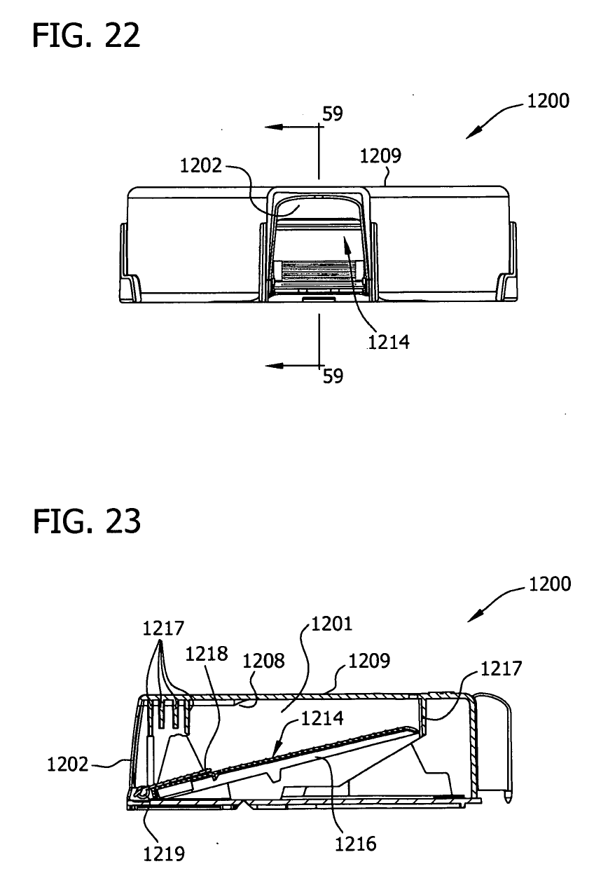

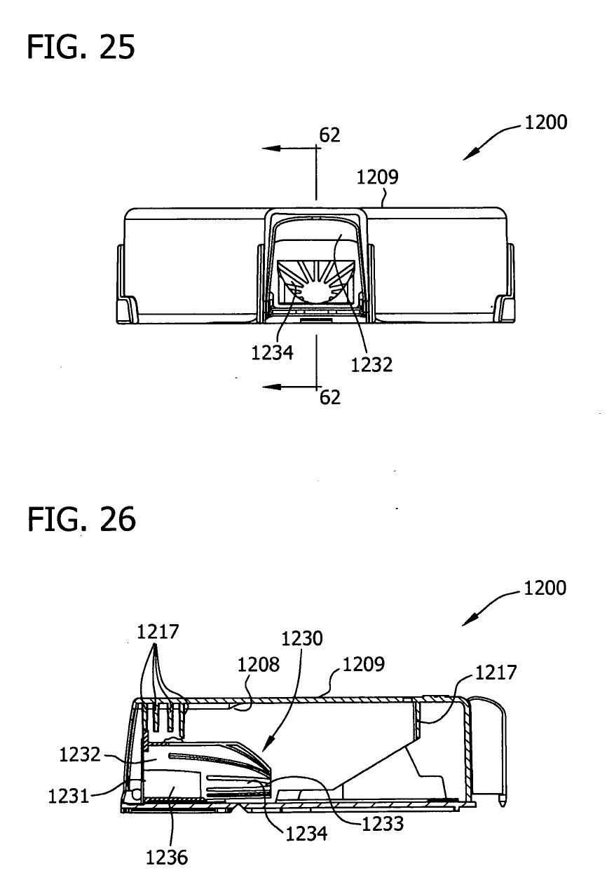

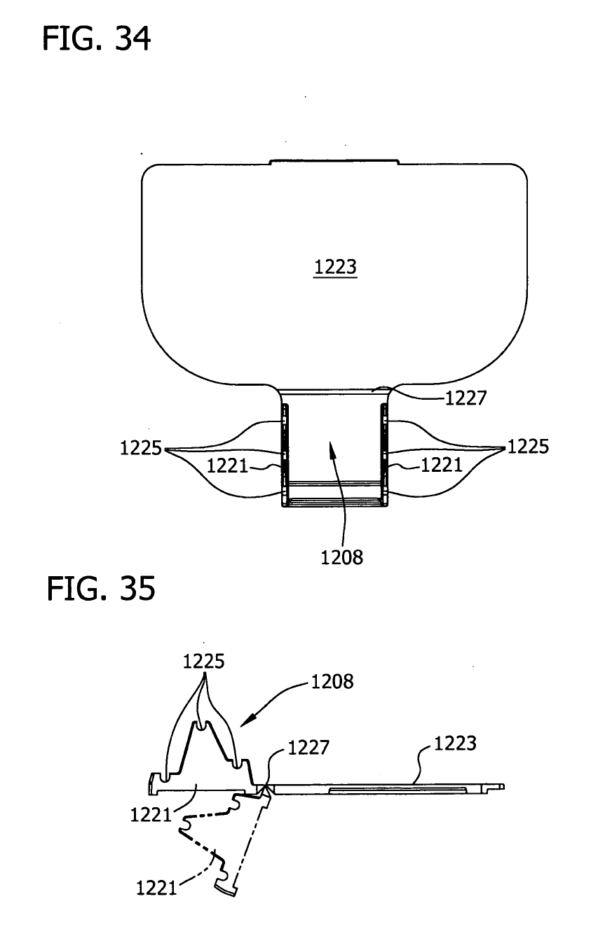

FIGS. 20-35 illustrate another embodiment of a live trap 1200 that has a substantially different exterior design from the traps of the previous embodiments. In particular, the live trap 1200 (as best seen in FIG. 20) of this embodiment has a trap portion 1201 (as best seen in FIG. 23), a relatively narrower tunnel portion 1208 extending from and open to the trap portion, and one or more entry openings 1202 formed in an end of the tunnel portion 1208 of the live trap. As seen in FIG. 20, the live trap comprises one or more sidewalls that curve outward and are substantially rounded where the tunnel portion 1208 meets or transitions to the trap portion.

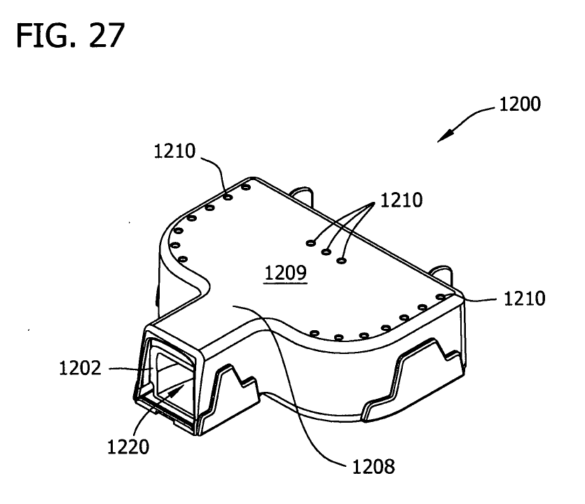

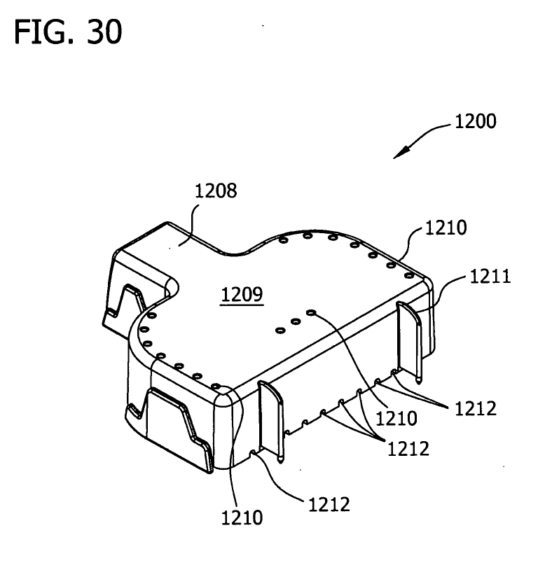

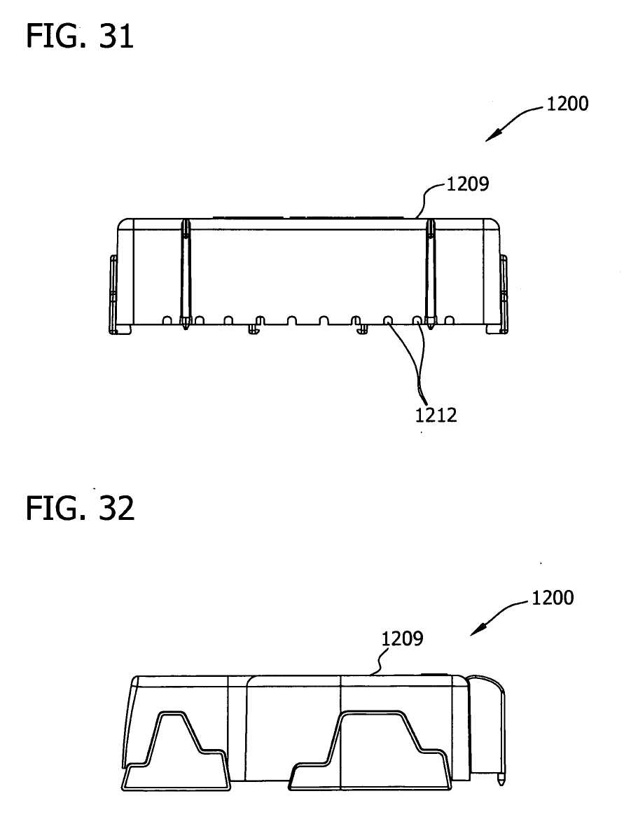

The illustrated live trap 1200 includes a number of vent openings in the form of vent holes 1210 (as best seen in FIG. 27) disposed in a top or an upper surface 1209 of the live trap and more suitably of the trap portion 1201 thereof. Additional vent holes vent holes 1212 (as best seen in FIGS. 30 and 31) are disposed in the rear 1211 of the live trap 1200 and more suitably of the trap portion 1201. The vent holes 1210 and additional vent holes 1212 are suitably sized to prevent passage of a rodent therethrough and as such are substantially smaller than the entry openings 1202 of the live trap 1200, while still permitting the passage of air, light, and particulates between the interior (i.e., trap portion) of the live trap and fluid communication therebetween. According to other embodiments, the vent holes 1210, 1212 may be disposed at different locations on the live trap 1200, such as along the sides of the live trap.

A variety of suitable internal trap mechanisms may be used within the live trap 1200, and in particular in the tunnel portion 1208 of the trap, to trap rodents within the enclosure portion of the trap. For example, in one embodiment the internal trap mechanism may comprise a ramp mechanism 1214 as illustrated in FIGS. 20, 22, and 23. The ramp mechanism 1214 comprises a ramp 1216 extending longitudinally within the tunnel portion 1208 of the live trap 1200 and having an entry end nearest the entry opening 1202 of the trap and an exit end nearest the enclosure portion of the trap. The ramp 1216 is mounted on the floor of the live trap 1200 for pivoting movement. A trap door 1218 is pivotally connected to the ramp generally adjacent the entry end of the ramp by a suitable pivot pin 1219. A spring, weight or other device is used to bias the ramp 1216 in a position in which the ramp slants upward as illustrated in FIG. 23 with the entry end of the ramp down near the floor of the live trap 1200. In this position, the trap door 1218 lays generally flat against the ramp 1216 to permit a rodent that enters the trap to proceed up the ramp over the trap door.

As the rodent proceeds past the trap door 1218, the weight of the rodent causes the ramp 1216 to pivot downward (i.e., to pivot the exit end downward). This pivoting of the ramp 1216 causes the entry end of the ramp to rise, pushing the trap door to pivot about the pin 1219 to an upright position (not shown) within the tunnel portion 1208 of the trap 1200 thus preventing the rodent from turning around and exiting the trap. The rodent must therefore continue past the ramp 1216 and into the trap portion 1201 of the live trap 1200. Once the rodent is off of the ramp 1216, the ramp returns to its initial position (FIG. 23) with the trap door 1218 again lying generally flat against the ramp. In particularly suitable embodiments, adhesive such as in the form of a glue board, may be disposed on the floor of the trap portion of the live trap 1200 to inhibit further movement of the rodent once it enters the trap portion, or at least travels to a particular area within the trap portion such as away from the entrance of the tunnel portion 1208 into the trap portion.

In some embodiments, the ramp 1216 is not utilized. In these embodiments, the trap door (broadly, a “gate”) 1218 is pivotable generally between an up position in which the gate generally closes off the entry opening 1202 of the live trap 1200 from the remainder of the trap and a down position in which a rodent can pass from the entry opening through the tunnel portion 1208 of the trap. FIGS. 23 and 29 illustrate a number of depending protrusions (broadly, “blocking members”) 1217 which extend downward from the upper surface 1209 of the live trap 1200. The depending protrusions 1217 prevent a rodent which has reached the enclosure portion of the live trap 1200 from tampering or manipulating the trap mechanism to escape from the live trap. In embodiments utilizing the trap door 1218, the depending protrusions are disposed generally above the trap door in the up position thereof and may be arranged longitudinally along the tunnel portion 1208 from a position intermediate the entry opening 1202 and the trap door 1218 in the up position to location past the trap door in the position. In embodiments utilizing the ramp 1216 the depending protrusions 1217 prevent the rodent from pivoting the ramp 1216 and restricting additional rodents from reaching the enclosure portion. Furthermore, the depending protrusions 1217 are suitably used with any of the trap mechanisms discussed herein and function in a similar manner to prevent rodents from manipulating the live trap mechanism after they have passed therethrough.

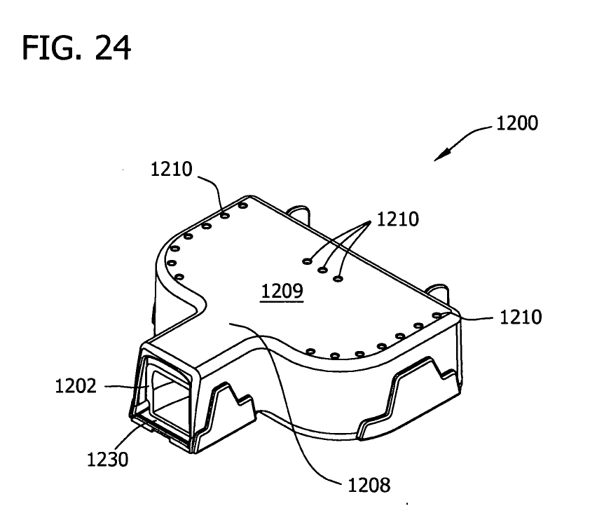

With reference to FIGS. 24, 25, and 26, another live trap mechanism is referred to herein as a funnel trap mechanism 1230 comprising a funnel 1232. The funnel 1232 sits within the tunnel portion 1208 of the live trap 1200 and has a first or entry end 1231 nearest the entry opening 1202 of the trap and an exit end 1233 nearest the enclosure portion of the trap. The funnel 1232 more suitably comprises a rigid segment 1236 extend longitudinally downstream from the entry end 1231 of the funnel and a flexible segment comprising a plurality of fingers 1234 attached to and extending longitudinally downstream from the rigid segment of the funnel to the exit end 1233 thereof. The rigid segment 1236 of the illustrated funnel 1232 is generally cylindrical or rectangular in shape with a constant cross-sectional area along its length. Although it is understood that the rigid segment 1236 may be shaped other than cylindrical or rectangular, and may be of non-uniform cross-section, without departing from the scope of this invention.

The fingers 1234 are configured to angle inward (relative to the centerline of the funnel 1232) toward each other such that the exit end 1233 of the funnel is substantially narrower than the entry end 1231 of the funnel. The fingers 1234 are suitably flexible and resilient to permit outward bending of the fingers against the bias thereof as the rodent passes through the flexible segment of the funnel to the exit end 1233 of the funnel. As a rodent moves through the exit end 1233 of the funnel, the bias of the fingers 1234 causes the tips of the fingers to remain in contact with the body of the rodent. If the rodent tries to reverse course, the tips of the fingers 1234 dig into or otherwise apply pressure to the rodent, thereby encouraging the rodent to continue moving forward to the enclosure portion of the trap. Once the rodent exits the funnel 1232, the fingers 1234 return to their initial position, thus rendering the exit end 1233 of the funnel too narrow for the rodent's head to fit through so the rodent cannot move back through the funnel. In addition, the funnel trap mechanism 1230 utilizes the depending protrusions 1217 to prevent the rodent from exiting the live trap 1200 by passing over the funnel trap mechanism 1220.

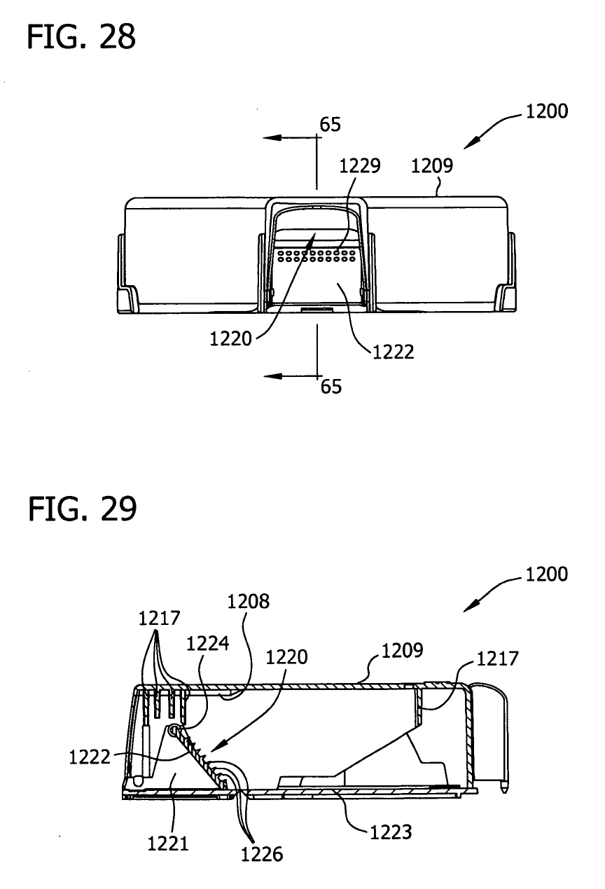

FIGS. 27, 28, and 29 illustrate an alternative trap mechanism, referred to herein as a swing door mechanism 1220. The swing door mechanism 1220 comprises a swing door 1222 that is pivotably attached by a pivot pin 1224 to a base extension 1221 of the live trap 1200 within the tunnel portion 1208 of the trap, suitably near the entry opening 1202 to the trap. The base extension 1221 is coupled to a bottom surface 1223 of the live trap 1200. The swing door 1222 is suitably sized in length longer than the interior height of the tunnel portion 1208 of the trap 1200 so that in its initial position it contacts the floor of the trap in a slightly angled orientation of the door. In this manner, the door 1222 is capable of swinging only one way, i.e., inward toward the enclosure portion of the trap 1200. In the illustrated embodiment, the swing door 1222 also has teeth 1226 positioned along its free edge and its planar surface facing inwards toward the enclosure portion. In the illustrated embodiment, the swing door 1222 has slots or openings 1229 (FIG. 28) disposed therein, thus enabling light to pass through the swing door.

As the rodent enters the live trap 1200 with the swing door mechanism 1220 they come into contact with the swing door 1222 and cause it to rotate upward about the pivot pin 1224. If the rodent attempts to retreat from the trap 1200 while passing beneath the swing door 1222, the teeth 1226 at the free end and the inward planar surface facing of the swing door bite into the rodent to discourage such rearward movement. After the rodent has cleared the swing door 1222, the door pivots back to its initial state, thus blocking any retreat by the rodent. While teeth 1226 are depicted in FIG. 29 as being positioned along the free edge of the swing door 1222 and planar surface facing inwards towards the enclosure portion, they may be positioned along any portion of the swing door. In addition, the swing door mechanism 1220 utilizes the depending protrusions 1217 to prevent the rodent from exiting the live trap 1200 by passing over the swing door mechanism 1220.

In other embodiments an additional swing door positioned in front of the swing door 1222 may be provided. In such an embodiment, the additional swing door does not have teeth and is sized to permit the swinging of the door in both directions within the swing door trap 1220. The rodent is thus able to exit through this additional door before coming into contact with the swing door 1222. The rodent is encouraged by this additional door that it is capable of retreat from the trap and to thus continue through the next door, which is the swing door 1222. The additional swing door and swing door 1222 generally function in the same manner. Like the swing door 1222, the additional swing door may have slots positioned in any portion therein. The base extensions 1221 extends upward from the bottom surface 1223 and have recesses 1225 formed therein. The base extensions 1221 may be formed integrally with the bottom surface 1223 or they may formed separately and suitably coupled thereto. The recesses 1225 are suitably sized to receive portions of trap mechanisms placed therein. For example, the recesses 1225 are sized and positioned to receive the pivot pin 1224 of the swing door mechanism 1220 as shown in FIG. 29. The recesses 1225 are also sized and positioned to receive the pivot pin 1219 of the ramp mechanism 1214 as shown in FIG. 23 and a portion of either the funnel 1232 or the rigid segment 1236 thereof of the funnel trap mechanism 1230 as shown in FIG. 26.

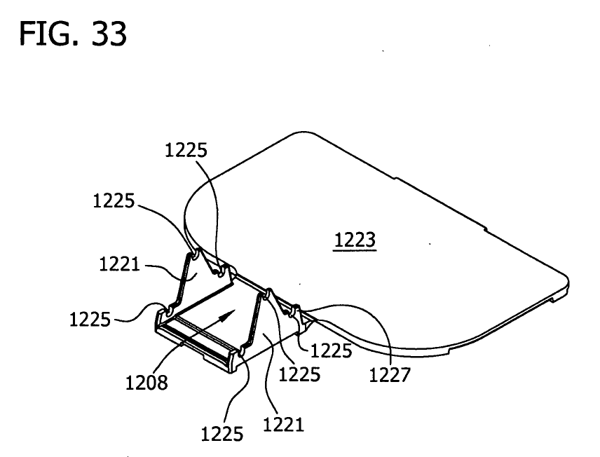

FIGS. 33, 34, and 35 illustrate perspective, top, and side views of the bottom panel 1223 of the live trap 1200. A portion of the bottom panel 1223, and in particular along the tunnel portion 1208 of the live trap 1200, broadly defines an access panel 1225 that is selectively separable from the rest of the bottom panel to provide access to the trap mechanism within the live trap to permit servicing of the live trap (e.g., removal of rodents and debris therefrom and changing of trap mechanisms). In a particularly suitable embodiment a living hinge 1227 hingedly connects the access panel 1225 to the rest of the bottom panel 1223. The access panel 1225 is thus positionable between a closed position in which an access opening of the live trap 1200 and more particularly the tunnel portion 1208 is closed and an opened position. In the opened position, the trap mechanisms are insertable, removable, and serviceable through the access opening. Accordingly, the entire bottom panel 1223 does not have to be separated from the remainder of the live trap 1220 to change the trap mechanisms placed therein. The bottom panel 1223 may also (or instead) include a trap access panel (not shown) separate from the access panel 1225 and more particularly along the trap portion, to permit servicing of the trap such as to remove rodents from the trap portion of the trap.

When introducing elements of the present invention or the embodiment(s) thereof, the articles “a,” “an,” “the,” and “said” are intended to mean that there are one or more of the elements. The terms “comprising,” “including,” and “having” are intended to be inclusive and mean that there may be additional elements other than the listed elements.

As various changes could be made in the above products and methods without departing from the scope of the invention, it is intended that all matter contained in the above description and shown in the accompanying drawings shall be interpreted as illustrative and not in a limiting sense.

What is claimed is:

1. A live trap for trapping rodents, the live trap comprising a housing having an interior space and at least one opening through which rodents enter the interior space of the housing, a first trap mechanism positionable in the live trap for trapping rodents within the live trap and a second trap mechanism different from the first trap mechanism and positionable in the live trap for trapping rodents within the live trap, the live trap and trap mechanisms being configured for selective releasable securement of each the respective first and second trap mechanisms in the live trap to permit interchangeable use of the first and second trap mechanisms in the live trap.

2. The live trap of claim 1 wherein the first trap mechanism comprises one of a funnel trap mechanism, a swinging gate mechanism, and a ramp mechanism, the second trap mechanism comprising a different one of the funnel trap mechanism, the swinging gate mechanism, and the ramp mechanism.

3. The live trap of claim 1 wherein the live trap further has an access opening and an access panel positionable between a closed position in which the access opening is closed and an opened position, the first and second trap mechanisms being insertable into and removable from the live trap through the access opening in the opened position of the access panel.

4. The live trap of claim 3 wherein the live trap has a trap portion in which rodents are trapped within the live trap, and an inlet portion in open communication with and extending outward from the trap portion of the live trap, the entry opening of the live trap being disposed in the inlet portion of the live trap, the access opening and access panel also being disposed at the inlet portion of the live trap.

5. The live trap of claim 3 wherein the access panel is hinged to the live trap.

6. The live trap of claim 3 wherein the housing comprises a top and a bottom, the access panel being disposed on the bottom of the live trap housing.

7. The live trap of claim 1 wherein the housing has a bottom panel defining at least in part a bottom of the housing, the bottom panel including a trap access panel substantially smaller than the bottom panel and positionable relative to the bottom panel between a closed position and an opened position in which the interior space of the housing is accessible for servicing.

8. The live trap of claim 1 wherein the housing has a bottom panel including an inner surface defining a floor of the live trap, the live trap further comprising a bridge assembly positioned within the interior space of the housing and having a platform configured to position one of the first and second trap mechanisms within the interior space of the live trap above the floor of the housing in spaced relationship therewith.

9. The live trap of claim 1 wherein the housing includes a base and a lid together at least in part defining the interior space of the housing, the lid being positionable relative to the base between a closed configuration of the station in which the interior space in substantially enclosed, and an opened configuration of the station in which the interior space is accessible for servicing.

10. A live trap for trapping rodents, the live trap comprising:
a housing having an interior space, a bottom having an inner surface at least in part defining the interior space, and at least one entry opening through which rodents enter the interior space of the housing;
at least one trap mechanism disposed within the interior space of the housing to inhibit rodents that enter the housing from exiting the housing; and
a bridge assembly positioned within the interior space of the housing, the bridge assembly including a platform spaced above the inner surface of the bottom of the housing and configured to support the at least one trap mechanism above the inner surface of the bottom of the housing, the bridge assembly extending above less than the entire inner surface of the bottom of the housing to permit rodents exiting the trap mechanism to step down from one of the bridge assembly and the at least one trap mechanism onto the inner surface of the bottom of the housing.

11. The live trap of claim 10 wherein the bridge assembly, at least where rodents exit the trap mechanism, is spaced above the inner surface of the bottom of the housing a distance in the range of about 1 to about 8 cm.

12. The live trap of claim 10 further comprising adhesive material disposed on the inner surface of the bottom of the housing to inhibit movement of rodents after the rodents step down onto the inner surface of the bottom of the housing.

13. The live trap of claim 10 wherein at least a portion of the bridge assembly is configured for releasable securement with the housing within the interior space of the housing.

14. The live trap of claim 10 wherein the bridge assembly comprises a first bridge assembly, the first bridge assembly being releasably positionable within the interior space of the housing, the live trap further comprising a second bridge assembly having a configuration different from the first bridge assembly and being interchangeable with the first bridge assembly within the interior space of the housing.

15. The live trap of claim 10 wherein the housing includes a base and a lid together at least in part defining the interior space of the housing, the lid being positionable relative to the base between a closed configuration in which the interior space is substantially enclosed, and an opened configuration in which the interior space is accessible for servicing, the base comprising a bottom panel defining the bottom of the housing and an upstanding wall extending up from the bottom panel, the bridge assembly abutting against the upstanding wall.

16. The live trap of claim 15 wherein the bridge assembly is at least in part supported by the upstanding wall above the inner surface of the bottom of the housing.

17. The live trap of claim 10 wherein the platform has an opening at least one of at and adjacent a location at which rodents exit the at least one trap mechanism such that rodents exiting the at least one trap step down through the opening onto the inner surface of the bottom of the housing.

18. The live trap of claim 10 wherein the platform has a terminal end at which rodents step off of the bridge assembly onto the inner surface of the bottom of the housing, said terminal end being one of at and adjacent a location at which rodents exit the at least one trap mechanism.

19. The live trap of claim 10 wherein the platform is configured for releasable securement to the bridge assembly.

20. A live trap for trapping rodents, the live trap comprising:
a housing having an interior space, a bottom panel having an inner surface at least in part defining the interior space, at least one upstanding wall extending up from the bottom panel, at least one entry opening through which rodents enter the interior space of the housing, and at least one inspection member separate from the at least one entry opening and disposed on at least one of the bottom panel and the at least one upstanding wall, the at least one inspection member configured to permit viewing of the interior space of the housing; and
at least one trap mechanism disposed within the interior space of the housing to inhibit rodents that enter the housing from exiting the housing.

21. The live trap of claim 20 further comprising a bridge assembly disposed within the interior space of the housing, the bridge assembly including a platform spaced above the inner surface of the bottom panel and configured to support the at least one trap mechanism above the inner surface of the bottom of the housing.

22. The live trap of claim 21 wherein the at least a portion of the bridge assembly is transparent to facilitate viewing of the interior space of the housing.

23. The live trap of claim 20 wherein the housing has a front, a rear, a bottom defined at least in part by the bottom panel of the housing, and a top, the upstanding wall at least in part defining the rear of the housing.

24. The live trap of claim 20 wherein the at least one inspection member comprises a portion of at least one of the bottom panel and the upstanding wall being one of transparent and translucent.

25. The live trap of claim 20 wherein the at least one inspection member comprises a plurality of openings disposed in at least one of the bottom panel and the upstanding wall.

26. The live trap of claim 25 wherein the at least one inspection member comprises a plurality of slots disposed in at least one of the bottom panel and the upstanding wall.

27. The live trap of claim 20 wherein the housing includes a base and a lid together at least in part defining the interior space of the housing, the lid being positionable relative to the base between a closed configuration in which the interior space is substantially enclosed, and an opened configuration in which the interior space is accessible for servicing, the base comprising the bottom panel and upstanding wall.

28. The live trap of claim 21 wherein the platform of the bridge assembly has one or more openings formed therein.

29. The live trap of claim 28 wherein the one or more openings formed in the platform of the bridge assembly are disposed beneath the at least one trap mechanism.

30. The live trap of claim 29 wherein the one or more openings are sized and shaped to permit a rodent to pass therethrough, thus preventing the rodent from interfering with operation of the at least one trap mechanism.

31. A live trap for trapping rodents, the live trap comprising:
a housing having an interior space, a bottom panel including an inner surface at least in part defining the interior space of the housing, and at least one entry opening through which rodents enter the live trap, the bottom panel including an access opening and an access panel positionable between a closed position for of use of the live trap and an opened position for servicing of the live trap; and
a trap mechanism releasably positionable in the live trap for trapping rodents within the live trap, the trap mechanism being disposed within the interior space of the housing in sufficient proximity to the access opening to permit access to the trap mechanism in the opened position of the access panel.

32. The live trap of claim 31 wherein the live trap and trap mechanism are configured for releasable securement of the trap mechanism within the interior space of the housing, the access opening being sized to permit the trap mechanism to pass through the access opening in the opened position of the access panel.

33. The live trap of claim 31 wherein the live trap has a trap portion in which rodents are trapped within the live trap, and an inlet portion narrower than the trap portion and in open communication with and extending outward from the trap portion of the live trap, the entry opening of the live trap being disposed in the inlet portion of the live trap, the trap mechanism, access opening and access panel also being disposed at the inlet portion of the live trap.

34. The live trap of claim 31 wherein the access panel is hinged to the bottom panel of the housing.

35. The live trap of claim 33 wherein the housing further has a trap portion opening separate from the access opening and disposed in the trap portion of the live trap, and a closure panel positionable between a closed position in which the trap portion opening is closed, and an opened position to access the interior space of the housing for servicing.

36. A live trap for trapping rodents, the live trap comprising:
a housing having an interior space, a top, a bottom panel including an inner surface at least in part defining the interior space of the housing, and at least one entry opening through which rodents enter the live trap, the housing comprising a trap portion in which rodents are trapped within the live trap, an inlet portion in open communication with and extending outward from the trap portion, the entry opening of the housing being at the inlet portion thereof; and
a trap mechanism disposed at least in part within the inlet portion of the housing in spaced relationship with the entry opening of the live trap, the housing further comprising a plurality of blocking members depending from the top of the housing at the inlet portion and arranged in longitudinally spaced relationship with each other along the inlet portion to inhibit rodents trapped within the live trap against manipulating the trap mechanism to escape from the trap.

37. The live trap of claim 36 wherein the trap mechanism comprises one of a funnel trap mechanism, a swinging gate trap mechanism, and a ramp trap mechanism.

38. The live trap of claim 37 wherein the trap mechanism includes a gate capable of pivoting movement relative to the top and the bottom panel of the live trap between a generally up position in which the gate generally closes off the entry opening of the live trap from the remainder of the interior of the trap, and a down position in which a rodent can pass from the entry opening through the inlet portion to the trap portion of the trap, at least one of the blocking members being disposed generally above the gate in the up position thereof.

39. The live trap of claim 38 wherein the blocking members are arranged longitudinally along the inlet portion from a location intermediate the entry opening and the gate in the up position thereof to a location past the gate in the up position thereof.

40. The live trap of claim 38 wherein the gate is biased toward its up position.

41. The live trap of claim 38 wherein the trap mechanism comprises a ramp trap mechanism including the gate.
